(19) United States
(12) Patent Application Publication
(10) Pub. No.: US 2001/0042143 A1
(43) Pub. Date: Nov. 15, 2001

(54) Memory access system in which processor generates operation request, and memory interface accesses memory, and performs operation on data

(75) Inventors: Yasuhiro Ooba, Kawasaki (JP); Masami Yamazaki, Kawasaki (JP); Takeshi Toyoyama, Osaka (JP); Masaharu Imai, Hyogo (JP); Yoshinori Takeuchi, Osaka (JP); Akira Kitajima, Osaka (JP)

Correspondence Address: HELFGOTT & KARAS, P.C., 60TH FLOOR, EMPIRE STATE BUILDING, NEW YORK, NY, 10118, US

(73) Assignee: Fujitsu Limited

(21) Appl. No.: 09/753,838

(22) Filed: Jan. 3, 2001

(30) Foreign Application Priority Data
May 12, 2000 (JP) 2000-139859

(51) Int. Cl. G06F 13/28

(52) U.S. Cl. 710/22

(57) ABSTRACT

A memory access system includes a memory, a processor unit, and a memory interface unit. The processor unit includes an operation-request generating unit and an operation-request sending unit. The operation-request generating unit generates an operation request for an operation which is to be performed on the data stored in the memory, and the operation-request sending unit sends the operation request to a memory interface unit. The memory interface unit includes an operation-request storing unit, an operation performing unit, and an operation-result sending unit. The operation-request storing unit receives and stores the operation request. The operation performing unit operates independently of the processor unit so as to access the memory based on the operation request, and perform the operation on the data. The operation-result sending unit sends a result of the operation to the processor unit.

### BACKGROUND OF THE INVENTION

1. Field of the Invention

The present invention relates to a memory access system which realizes memory access and execution of an operation on data stored in the memory. The present invention further relates to an ATM communication control apparatus which accesses a memory, and performs operation on data stored in the memory for controlling ATM communication.

2. Description of the Related Art

In the conventional information processing apparatuses used in the data communication systems, a central processing unit (CPU) executes processing, and a memory (main storage) stores data. In particular, the CPU controls memory access operations, and performs operations on data stored in the memory.

FIG. 25 is a diagram illustrating a typical sequence of operations performed by the CPU in the conventional information processing apparatuses. In FIG. 25, successive occurrences of events and a sequence of operations performed by the CPU corresponding to the events are illustrated along a time axis. When an event A occurs, the CPU starts processing of the event A. When a time T elapses, the next event B occurs, and the CPU starts processing of the event B. Likewise, the CPU processes events which subsequently occur. As indicated in FIG. 25, the CPU processes each event as follows.

In step S100, the CPU determines data to be processed and an operation to be performed on the data, and executes preprocessing including recognition of a memory address which indicates the location of the data. In step S101, the CPU reads data based on the memory address. In step S102, the CPU performs the operation on the data, e.g., an operation of addition. In step S103, the CPU writes a result of the processing in the memory.

As described above, conventionally, the CPU performs necessary functions by repeating a sequence of operations such as reading data from a memory, performing an operation on the data, writing the result of the operation in the memory. However, conventionally, the CPU cannot start processing of an event until processing of a previous event is completed.

FIG. 26 is a diagram illustrating a sequence of operations performed on a plurality of data items. In FIG. 26, successive occurrences of events and a sequence of operations performed by the CPU for one of the events are illustrated along a time axis. In the example of FIG. 26, two data items are updated.

When an event A occurs, the CPU starts processing of data items d1 and d2 relating to the event A, and the processing is executed as follows.

In step S110, the CPU determines an operation which is to be performed on each data item, and executes preprocessing, which includes recognition of memory addresses which indicate the locations of the data items. In step S11, the CPU reads the data item d1 based on the corresponding memory address. In step S112, the CPU reads the data item d2 based on the corresponding memory address. In step S113, the CPU performs an operation on the data item dl. In step S114, the CPU performs an operation on the data item d2. The operations performed in step S113 and 114 are, for example, addition. In step S115, the CPU writes a result of the operation performed in step S113 in the memory. In step S116, the CPU writes a result of the operation performed in step S114 in the memory.

In the above sequence, when another event B occurs a time T after the occurrence of the event A, and the processing of the plurality of data items for the event A is not completed at the time of the occurrence of the event B, as illustrated in FIG. 26, the CPU cannot execute processing of the event B. Therefore, the processing efficiency is low, and the operation quality of the CPU is lowered.

FIG. 27 is a diagram illustrating a sequence of operations in pipeline processing. In FIG. 27, successive occurrences of events and operations performed by the CPU corresponding to the events are illustrated along a time axis.

When an event A occurs, the CPU executes preprocessing of data for the event A in step S120. When an event B occurs, the CPU executes preprocessing of data for the event B in step S121. In addition, the CPU reads out data for the event A. In step S122, the CPU reads out data for the event B, and performs an operation for updating the data for the event A. When an event C occurs, the CPU executes preprocessing of data for the event C in step S123. Thereafter, the operations illustrated in FIG. 27 are performed for the events A, B, and C.

However, in the case where the processing of the event B uses data updated by the processing of the event A, the data is read for the processing of the event B during the updating operation of the data in the processing of the event A, and therefore wrong data is read for the processing of the event B. Therefore, an error occurs in the processing result for the event B. This problem is known as the pipeline hazard.

As described above, when pipeline processing is executed, the total throughput is improved. However, in this case, when the same data item is successively accessed by the CPU in processing of different events, the pipeline hazard occurs.

On the other hand, connection-oriented ATM (Asynchronous Transfer Mode) communication techniques for transmitting multimedia data are currently under development. According to the connection-oriented ATM (Asynchronous Transfer Mode) communication techniques, multimedia data including digital data, sound, moving image, and the like are transmitted to users at speeds and quality levels determined for the respective users. Since each ATM communication system handles a great number of connections, a memory having great capacity is needed. In addition, since the ATM communication system also handles a great amount of data, the great majority of operations performed in the ATM communication system are memory access operations.

In particular, when processing for counting the number of received ATM cells, statistical processing for OAM (Operation and Maintenance) performance monitoring, processing for billing based on the number of transferred ATM cells, and the like are executed in the ATM communication system in the conventional manners as described with reference to FIG. 25, the aforementioned problems in the conventional data communication systems arise, since the above processing is required to be executed at high speed, i.e., real-time processing is required.

If the data width between the CPU and the memory is increased, or the clock frequency is increased, in order to avoid the above problems, a pin neck occurs, or power consumption is increased. Further, if the above processing, which is required to be executed at high speed, is realized by a dedicated hardwired logic circuit such as an ASIC (Application Specific Integrated Circuit) in order to avoid the above problems, it is impossible to flexibly adapt the data communication systems to changes of standards (such as the ITU-T standards) or design specifications.

### SUMMARY OF THE INVENTION

An object of the present invention is to provide a memory access system which realizes memory access and execution of an operation on data stored in the memory, improves quality and efficiency of the memory access operations, and increases system throughput.

Another object of the present invention is to provide a memory interface unit which accesses data stored in a memory, performs an operation on the data, improves quality and efficiency of the memory access operations, and increases system throughput.

A further object of the present invention is to provide an ATM communication control apparatus which controls ATM communications, improves quality and efficiency of the memory access operations, and increases system throughput.

According to the first aspect of the present invention, there is provided a memory access system comprising a memory, a processor unit, and a memory interface unit. The memory stores data. The processor unit includes an operation-request generating unit and an operation-request sending unit. The operation-request generating unit generates an operation request for an operation which is to be performed on the data, and the operation-request sending unit sends the operation request to a memory interface unit. The memory interface unit includes an operation-request storing unit, an operation performing unit, and an operation-result sending unit. The operation-request storing unit receives and temporarily stores the operation request. The operation performing unit operates independently of the processor unit so as to access the memory based on the operation request, and perform the operation on the data. The operation-result sending unit sends a result of the operation to the processor unit.

As explained above, in the memory access system according to the first aspect of the present invention, the processor unit does not directly access the memory. Instead, the processor unit only generate an operation request, and sends the operation request to the memory interface unit, and the memory interface unit accesses the memory, and performs an operation on data based on the operation request independently of the operation of the processor unit. Therefore, the bandwidth between the processor unit and the memory interface unit can be reduced, and efficient, high-quality memory access control can be achieved. Thus, the system throughput can be improved.

The memory access system according to the first aspect of the present invention may also have one or any possible combination of the following additional features (i) to (xix).

(i) The operation request may contain a memory address and an operand which indicates the operation.

(ii) In the memory access system having the above additional feature (i), the operand may include an operation operand which indicates a type of the operation and a data operand which indicates additional data used in the operation.

(iii) In the memory access system having the above additional feature (ii), the operation operand may include at least one of first, second, and third bits, where the first bit indicates an operation of clearing the data stored in the memory, the second bit indicates an immediate update operation of updating (replacing) the data with the additional data, and the third bit indicates an operation of masking the data.

(iv) In the memory access system having the above additional feature (iii), the operation performing unit may perform the operation of clearing the data stored in the memory, or the immediate update operation, without read access to the memory.

(v) In the memory access system having the above additional feature (ii), the operand may include at least one mask bit which masks the data stored in the memory.

(vi) In the memory access system having the above additional feature (ii), the operation operand may be encoded.

(vii) In the memory access system having the above additional feature (ii), the operation may be performed on a plurality of portions of the data, and the data operand may include a plurality of portions respectively corresponding to the plurality of portions of the data.

(viii) In the memory access system having the above additional feature (ii), the operation request may include an address continuation indication which indicates that the data on which the operation is to be performed is stored at a plurality of consecutive addresses of the memory, and the memory address contained in the operation request may be one of the plurality of consecutive addresses.

(ix) In the memory access system having the above additional feature (viii), the plurality of consecutive addresses may be n consecutive addresses, and the operation performing unit may perform n successive data reading operations, the operation to be performed on the data, and n successive data writing operations.

(x) The operation-request storing unit may comprise a queue which stores the operation request, and an operation-request controlling unit which controls the operation request stored in the queue.

(xi) In the memory access system having the above additional feature (x), the operation-request controlling unit may successively read from the queue a plurality of operation requests having an identical memory address, with high priority.

(xii) In the memory access system having the above additional feature (x), the operation-request controlling unit may successively read from the queue a plurality of operation requests respectively containing a plurality of consecutive memory addresses, with high priority.

(xiii) In the memory access system having the above additional feature (x), the operation-request controlling unit may invalidate a plurality of operation requests containing an identical memory address and being stored in the queue, and generate an accumulated operation request by accumulating a plurality of operations requested by the plurality of operation requests.

(xiv) In the memory access system having the above additional feature (x), the operation-request controlling unit may invalidate at least one operation request being stored in the queue and containing a memory address which is identical to a memory address contained in an operation request which is to be written in the queue, and generate an accumulated operation request by accumulating a plurality of operations requested by the at least one operation request and the operation request which is to be written in the queue.

(xv) In the memory access system having the above additional feature (x), when the queue is full of operation requests, the operation-request controlling unit may make the processor unit suspend processing of an operation request following the operation requests in the queue.

(xvi) In the memory access system having the above additional feature (x), the queue may comprise a random access queue and a ready queue.

(xvii) The operation-request storing unit may comprise a cache memory which stores a plurality of operation requests, and an operation-request controlling unit which controls the operation request stored in the cache memory, and accumulates a plurality of operations requested by a plurality of operation requests containing an identical memory address and being stored in the cache memory.

(xviii) When the operation performing unit reads from the memory first data corresponding to a first memory address contained in the operation request, the operation performing unit may also read second data corresponding to second memory addresses near the first memory address, and write in the memory results of operations performed on the second data corresponding to the second memory addresses, together with a result of the operation performed on the first data corresponding to the first memory address.

(xix) The processor unit may be realized by software, and the memory interface unit may be realized by hardwired logic circuits.

According to the second aspect of the present invention, there is provided a memory interface unit comprising an operation-request receiving unit which receives an operation request for an operation which is to be performed on data stored in a memory; an operation-request storing unit which temporarily stores the operation request; an operation performing unit which operates accesses the memory based on the operation request, and performs the operation on the data; and an operation-result outputting unit which outputs a result of the operation.

The memory interface unit according to the second aspect of the present invention may also have one or any possible combination of the aforementioned additional features (i) to (xix).

According to the third aspect of the present invention, there is provided an ATM communication control apparatus comprising a memory, a processor unit, and a memory interface unit. The memory stores data relating to control of ATM communications. The processor unit includes an operation-request generating unit and an operation-request sending unit. The operation-request generating unit generates an operation request for an operation which is to be performed on the data, and the operation-request sending unit sends the operation request to a memory interface unit. The memory interface unit includes an operation-request storing unit, an operation performing unit, and an operation-result sending unit. The operation-request storing unit receives and temporarily stores the operation request. The operation performing unit operates independently of the processor unit so as to access the memory based on the operation request, and perform the operation on the data. The operation-result sending unit sends a result of the operation to the processor unit.

In the ATM communication control apparatus according to the second aspect of the present invention, the throughput of the ATM system can be improved for the same reason as the first aspect of the present invention.

In the ATM communication control apparatus according to the second aspect of the present invention, the operation performed by the operation performing unit may relate to at least one of cell number counting, statistical processing for OAM performance monitoring, and billing.

The ATM communication control apparatus according to the third aspect of the present invention may also have one or any possible combination of the aforementioned additional features (i) to (xix).

The above and other objects, features and advantages of the present invention will become apparent from the following description when taken in conjunction with the accompanying drawings which illustrate preferred embodiment of the present invention by way of example.

### BRIEF DESCRIPTION OF THE DRAWINGS

In the drawings:

FIG. 1 is a diagram illustrating a basic construction of a memory access system according to the present invention;

FIG. 2 is a diagram illustrating a sequence of operations of the processor unit 10;

FIG. 3 is a diagram illustrating a sequence of operations of the memory interface unit 20, which are performed independently of the operation of the processor unit 10;

FIGS. 4 and 5 are timing diagrams of the operations of the memory access system 1;

FIG. 6 is a diagram illustrating a first example of the format of the operation request;

FIG. 7 is a diagram illustrating a second example of the format of the operation request;

FIG. 8 is a diagram illustrating a third example of the format of the operation request;

FIG. 9 is a diagram illustrating a fourth example of the format of the operation request;

FIG. 10 is a diagram illustrating a fifth example of the format of the operation request;

FIG. 11 is a diagram illustrating an example of the code table T1, which indicates correspondences between values of bits constituting the encoded operation operand OP12a-4 and the types of the operation represented by the encoded operation operand OP12a-4;

FIG. 12 is a diagram illustrating an exemplary case wherein two data items are stored at an address of the memory 30;

FIG. 13 is a diagram illustrating a sixth example of the operation request, which requests an operation to be performed on a plurality of data items;

FIG. 14 is a diagram illustrating a seventh example of the operation request, which requests an operation to be performed on a data item stored at more than one consecutive address of the memory 30;

FIG. 15 is a diagram illustrating an exemplary course of states of the random access queue 21a;

FIG. 16 is a diagram illustrating an example of the operation of accumulating more than one operation requested by more than one operation request stored in the random access queue 21a;

FIG. 17 is a diagram illustrating an example of the operation of accumulating operations requested by a newly received operation request and at least one operation request stored in the random access queue 21a;

FIG. 18 is a flow diagram illustrating examples of operations performed when the random access queue 21a is full of operation requests;

FIG. 19 is a diagram illustrating an example of the construction of the operation-request storing unit;

FIG. 20 is a diagram illustrating an outline of a construction of an ATM communication control apparatus;

FIG. 21 is a diagram illustrating insertion of PM cells between user cells for realizing performance monitoring;

FIGS. 22 to 24 are sequence diagrams of examples of operations performed for monitoring performance in a block;

FIG. 25 is a diagram illustrating a typical sequence of operations performed by the CPU in the conventional information processing apparatuses;

FIG. 26 is a diagram illustrating a sequence of operations performed on a plurality of items of data; and

FIG. 27 is a diagram illustrating a sequence of operations in pipeline processing.

### DESCRIPTION OF THE PREFERRED EMBODIMENTS

Embodiments of the present invention are explained below with reference to drawings.

(1) Principle of Invention

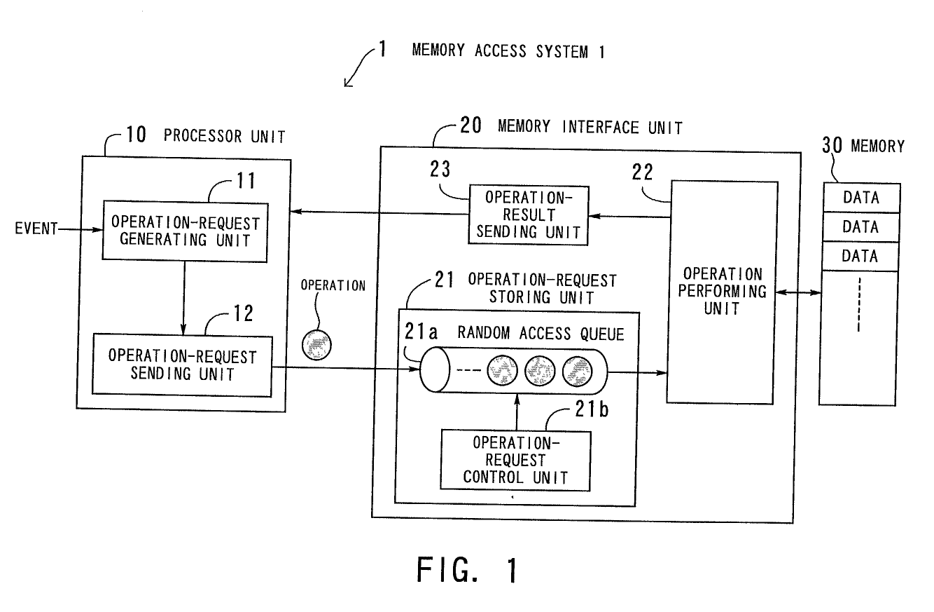

FIG. 1 is a diagram illustrating a basic construction of a memory access system according to the present invention.

The memory access system 1 of FIG. 1 comprises a processor unit 10, a memory interface unit 20, and a memory 30. The memory 30 is accessed by the processor unit 10 when the processor unit 10 performs various operations such as arithmetic calculation and comparison operation.

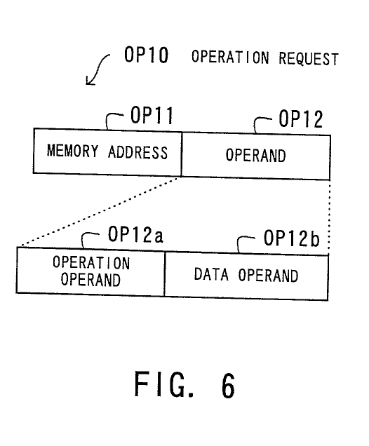

The processor unit 10 comprises an operation-request generating unit 11 and an operation-request transmitting unit 12, and corresponds to a so-called central processing unit (CPU). The operation-request generating unit 11 executes preprocessing when an event occurs. The preprocessing includes, for example, determination of data to be processed, and recognition of an operation to be performed on the data and a memory address which indicates the location of the data. The operation-request generating unit 11 also generates an operation request which indicates a request for the operation to be performed on the data. The structure of the operation request is explained later with reference to FIGS. 6 to 10, 13, and 14. The operation-request sending unit 12 sends the operation request to the memory interface unit 20.

The memory interface unit 20 comprises an operation-request storing unit 21, an operation performing unit 22, and a operation-result sending unit 23.

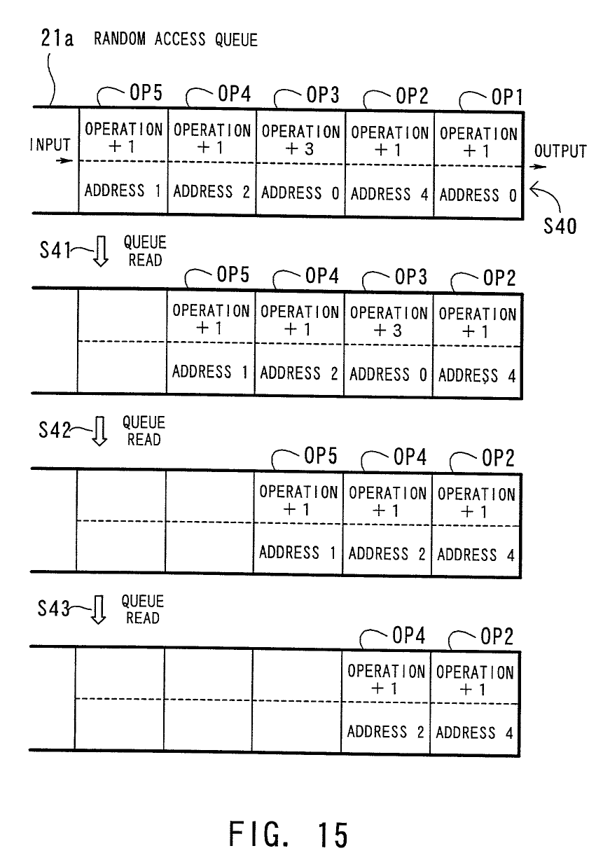

The operation-request storing unit 21 comprises a random access queue 21a and an operation-request control unit 21b. The random access queue 21a is a queue which is provided for storing at least one operation request sent from the processor unit 10, where each operation request can be written at or read from at a location of the operation-request storing unit 21 which is independent of another location of the operation-request storing unit 21 which another operation request has been previously written at or read from. The operation-request control unit 21b controls the operation requests in the random access queue 21a as explained later with reference to FIGS. 15 to 17.

The operation performing unit 22 accesses the memory 30 based on an operation request which is read out from the random access queue 21a, and performs an operation on data. The operation of the operation performing unit 22 is performed independently of the operation of the operation-request generating unit 11. The operation-result sending unit 23 sends a result of the operation performed by the operation performing unit 22 to the processor unit 10. The memory 30 is a main storage which stores data to be processed or data which have been processed.

For example, the functions of the operation-request generating unit 11 and the operation-request sending unit 12 in the processor unit 10 are realized by software, and the functions of the operation-request storing unit 21, the operation performing unit 22, and the operation-result sending unit 23 are realized by hardwired logic circuits. In this case, since the operation-request generating unit 11 is realized by software, the manner of the determination of data to be processed and an operation to be performed on the data can be changed by a program change. That is, the system becomes flexible.

The operations of the memory access system of FIG. 1 are explained below.

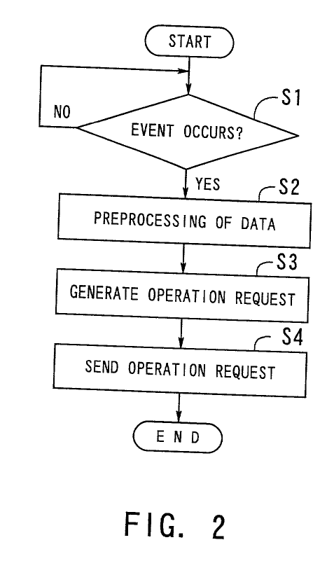

FIG. 2 is a diagram illustrating a sequence of operations of the processor unit 10. In step S1, the operation-request generating unit 11 determines whether or not an event occurs. When yes is determined in step S1, the operation goes to step S2. When no is determined in step S1, the operation of step S1 is repeated. In step S2, the operation-request generating unit 11 executes preprocessing, which includes determination of data to be processed and recognition of an operation to be performed on the data, and the like. In step S3, the operation-request generating unit 11 generates one or more operation requests indicating one or more operations to be performed on data. In step S4, the operation-request sending unit 12 sends the one or more operation requests to the memory interface unit 20.

The operations of the memory interface unit 20 are explained below.

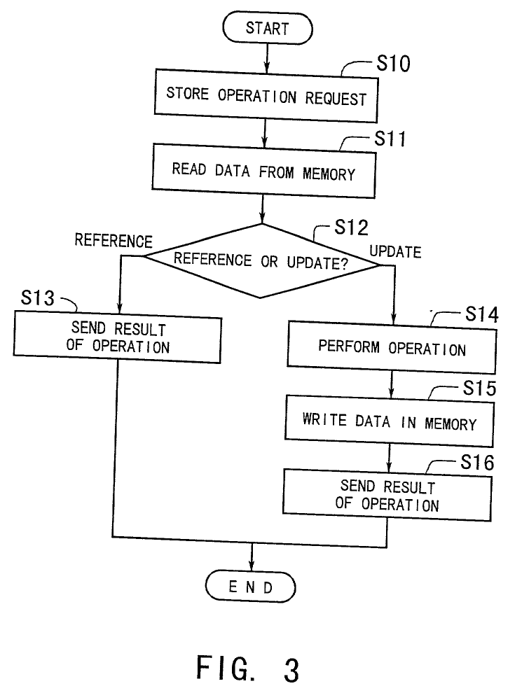

FIG. 3 is a diagram illustrating a sequence of operations of the memory interface unit 20, which are performed independently of the operation of the processor unit 10.

In step S10, the operation-request storing unit 21 stores one or more operation requests sent from the operation-request sending unit 12. In step S11, the operation performing unit 22 reads one of the operation requests stored in the operation-request storing unit 21, and reads data from the memory 30 based on the operation request. In step S12, the operation performing unit 22 determines whether the operation request indicates reference to data or update of data. When yes is determined in step S12, the operation goes to step S13. When no is determined in step S12, the operation goes to step S14. In step S13, the operation-result sending unit 23 sends a result of the reference (i.e., data read from the memory 30) to the processor unit 10. In step S14, the operation performing unit 22 executes processing for updating the data. In step S15, the operation performing unit 22 writes in the memory 30 a result of an operation performed on data. In step S16, the operation-result sending unit 23 sends the result of the update operation to the processor unit 10.

Hereinafter, unless otherwise specified, it is assumed that an operation performed on data is an operation for updating data.

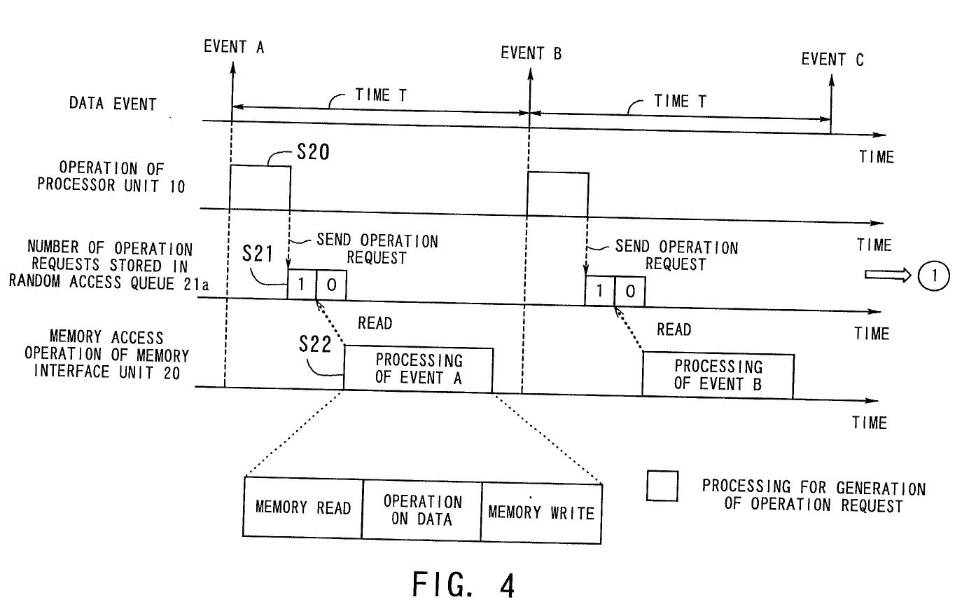

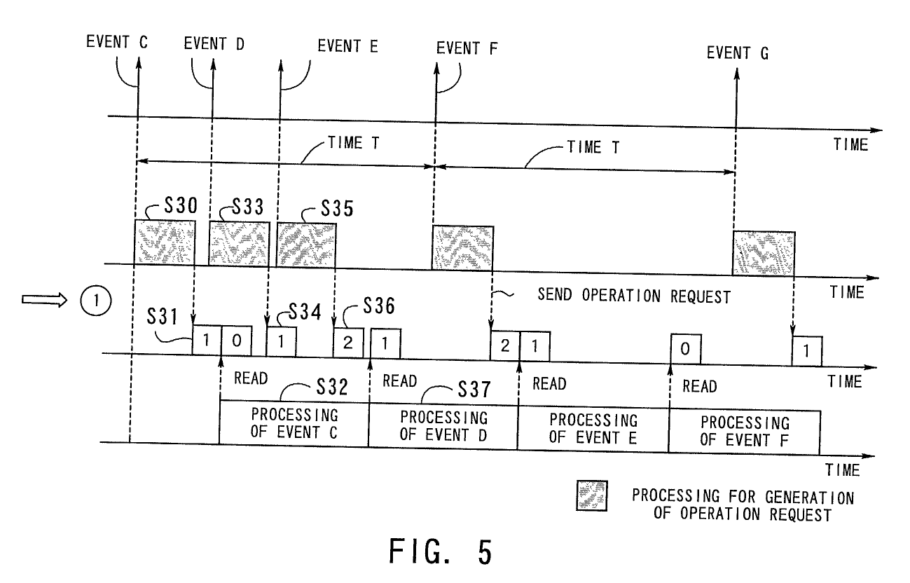

FIGS. 4 and 5 are timing diagrams of the operations of the memory access system 1. In FIGS. 4 and 5, occurrences of events, the operations of the processor unit 10, the number of operation requests accumulated in the random access queue 21a, and memory access operations performed by the memory interface unit 20 are illustrated along a time axis. FIG. 4 exhibits the operations of the memory access system 1 when events occur at intervals of a time T, and FIG. 5 exhibits the operations of the memory access system 1 when more than one event occurs within the interval T.

Referring to FIG. 4, when an event A occurs, in step S20, the processor unit 10 generates an operation request corresponding to the event A, and sends the generated operation request to the memory interface unit 20. In step S21, the random access queue 21a in the memory interface unit 20 stores the operation request corresponding to the event A, which is sent from the processor unit 10. At this time, the number of the operation request stored in the random access queue 21a is one. In step S22, the memory interface unit 20 reads the operation request corresponding to the event A from the random access queue 21a, and executes processing of the event A. Since the operation request is read out, the number of operation request stored in the random access queue 21a becomes zero. The processing includes an operation of reading data from the memory 30, an operation performed on the data, and an operation of writing the result of the operation performed on the data, in the memory 30. The operation performed on the data is, for example, an arithmetic or logical operation. The memory interface unit 20 performs similar operations for each event which occurs after the event A.

Referring to FIG. 5, when the event C occurs, in step S30, the processor unit 10 generates an operation request corresponding to the event C, and sends the generated operation request to the memory interface unit 20. In step S31, the random access queue 21a in the memory interface unit 20 stores the operation request corresponding to the event C, which is sent from the processor unit 10. At this time, the number of the operation request stored in the random access queue 21a is one. In step S32, the memory interface unit 20 reads the operation request corresponding to the event C from the random access queue 21a, and executes processing of the event C. Since the operation request corresponding to the event C is read out, the number of operation request stored in the random access queue 21a becomes zero. When another event D occurs during the processing of the event C by the memory interface unit 20, in step S33, the processor unit 10 generates an operation request corresponding to the event D, and sends the generated operation request to the memory interface unit 20. In step S34, the random access queue 21a in the memory interface unit 20 stores the operation request corresponding to the event D, which is sent from the processor unit 10. At this time, the number of the operation request stored in the random access queue 21a is one. When a further event E occurs during the processing of the event D by the memory interface unit 20, in step S35, the processor unit 10 generates an operation request corresponding to the event E, and sends the generated operation request to the memory interface unit 20. In step S36, the random access queue 21a in the memory interface unit 20 stores the operation request corresponding to the event E, which is sent from the processor unit 10. At this time, the number of the operation requests stored in the random access queue 21a becomes two. When the processing of the event C is completed, in step S37, the memory interface unit 20 reads the operation request corresponding to the event D from the random access queue 21a, and executes processing of the event D. Since the operation request corresponding to the event D is read out, the number of operation request stored in the random access queue 21a becomes one. The memory interface unit 20 performs similar operations for each event which occurs after the event D.

As explained above, in the memory access system 1 according to the present invention, the operations of the processor unit 10 and the memory interface unit 20 are performed independently of each other. The processor unit 10 does not directly exchange data with the memory 30. Instead, the processor unit 10 only sends the operation request corresponding to each event to the memory interface unit 20, and receives the result of processing from the memory interface unit 20. Therefore, the bandwidth between the processor unit 10 (which corresponds to the CPU) and the memory interface unit 20 can be reduced. In addition, the throughput can be improved without the pipeline processing.

Further, when an event occurs, the processor unit 10 does not execute processing of the event by itself, and only generates an operation request. Therefore, the time spent by the processor unit 10 for accessing the memory can be reduced, and the processor unit 10 can efficiently handle the events which occur at random times.

(2) Operation Request

FIG. 6 is a diagram illustrating the first example of the format of the operation request. The operation request OP10 is comprised of a memory address OP11 and an operand OP12. The memory address OP11 is an address at which data to be processed is stored in the memory 30, and the operand OP12 is information indicating an operation which is to be performed on the data. The operand OP12 is comprised of an operation operand OP12a and a data operand OP12b. The operation operand OP12a indicates the type of the operation, and the data operand OP12b indicates additional data used in the operation. For example, when data stored at the address “10” is required to be incremented by one, the memory address OP11 indicates “10”, the operation operand OP12a indicates “addition”, and the data operand OP12b indicates “1”. Alternatively, the operation operand OP12a may be “subtraction”, “shift operation”, “comparison operation”, or the like. In the comparison operation, for example, the value of the data stored at the memory address OP11 is compared with the value of the data operand OP12b, and it is determined whether or not the value of the data stored at the memory address OP11 is equal to the value of the data operand OP12b.

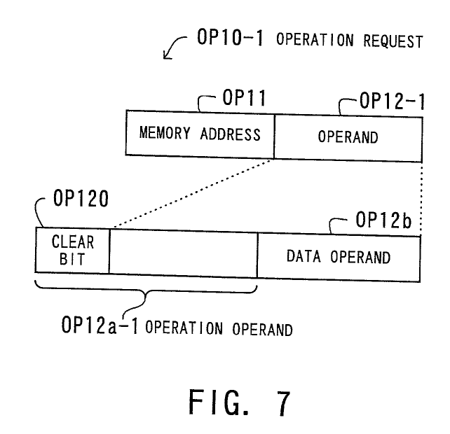

FIG. 7 is a diagram illustrating the second example of the format of the operation request. The operation request OP10-1 illustrated in FIG. 7 is comprised of the aforementioned memory address OP11 and an operand OP12-1, and the operand OP12-1 is comprised of an operation operand OP12a-1 and the aforementioned data operand OP12b. The format of the operation request OP10-1 illustrated in FIG. 7 is different from the format of the operation request OP10 illustrated in FIG. 6 in that the operation operand OP12a-1 further includes a clear bit OP120, which indicates whether or not the data stored at the memory address OP11 is requested to be cleared. For example, when the memory address OP11 is “10”, and the clear bit OP120 is “1”, the data stored at the memory address “10” is cleared (to the “ALL 0” state). That is, when the operation operand is extended to include the clear bit, the clear operation can be performed as well as the arithmetic and logical operations.

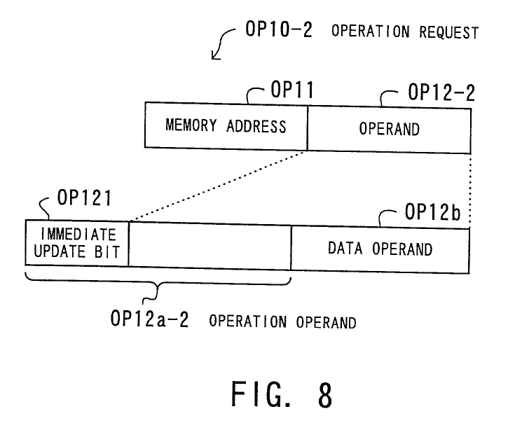

FIG. 8 is a diagram illustrating the third example of the format of the operation request. The operation request OP10-2 illustrated in FIG. 8 is comprised of the aforementioned memory address OP11 and an operand OP12-2, and the operand OP12-2 is comprised of an operation operand OP12a-2 and the aforementioned data operand OP12b. The format of the operation request OP10-2 illustrated in FIG. 8 is different from the format of the operation request OP10 illustrated in FIG. 6 in that the operation operand OP12a-2 further includes an immediate update bit OP121, which indicates whether or not immediate update (replacement) of data stored at the memory address OP11 is requested. For example, when the memory address OP11 is “10”, and the data operand OP12b is “FFFF”, and further the immediate update bit OP121 is “1”, the data stored at the memory address “10” is immediately replaced with “FFFF”, where it is assumed that the data width of the memory 30 is 32 bits. That is, when the operation operand is extended to include the immediate update bit, data stored at an arbitrary address can be replaced with an arbitrary value.

When the clear bit OP120 or the immediate update bit OP121 indicates “1”, the operation of reading data from the memory 30 is dispensed with. Therefore, the number of memory access operations can be reduced.

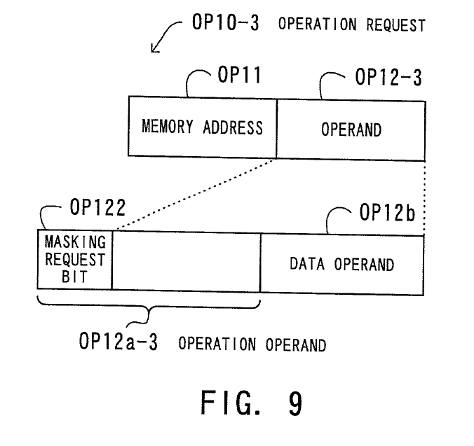

FIG. 9 is a diagram illustrating the fourth example of the format of the operation request. The operation request OP10-3 illustrated in FIG. 9 is comprised of the aforementioned memory address OP11 and an operand OP12-3, and the operand OP12-3 is comprised of an operation operand OP12a-3 and the aforementioned data operand OP12b. The format of the operation request OP10-3 illustrated in FIG. 9 is different from the format of the operation request OP10 illustrated in FIG. 6 in that the operation operand OP12a-3 further includes a masking request bit OP122, which indicates whether or not data stored at the memory address OP11 is requested to be masked by using the value of the data operand OP12b as a mask. For example, when the memory address OP11 is “10”, and the data operand OP12b is “1”, and further the masking request bit OP122 is “1”, the data stored at the memory address “10” is masked with the mask data “1”. That is, when the operation operand is extended to include the masking request bit, an arbitrary bit of data stored at an arbitrary address can be masked.

Although, in each of the above examples of FIGS. 7, 8, and 9, only one of the clear bit OP120, the immediate update bit OP121, and the mask bit OP122 is included in the operation operand, an arbitrary combination of the clear bit OP120, the immediate update bit OP121, and the mask bit OP122 can be included in the operation operand.

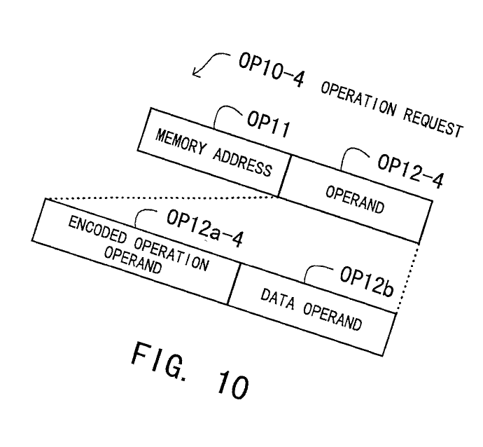

FIG. 10 is a diagram illustrating the fifth example of the format of the operation request. The operation request OP10-4 illustrated in FIG. 10 is comprised of the aforementioned memory address OP11 and an operand OP12-4, and the operand OP12-4 is comprised of an encoded operation operand OP12a-4 and the aforementioned data operand OP12b. The encoded operation operand OP12a-4 is encoded information which indicates the type of the operation as indicated by the operation operand OP12a or one or a combination of the clear bit OP120, the immediate update bit OP121, and the mask bit OP122.

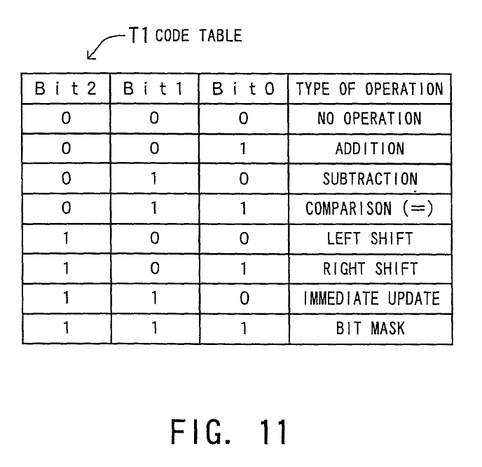

FIG. 11 is a diagram illustrating an example of a code table T1, which indicates the values of bits constituting the encoded operation operand OP12a-4 for each type of the operation represented by the encoded operation operand OP12a-4. That is, the encoded operation operand OP12a-4 in the example of FIG. 11 is represented by three bits, and indicates, as a type of the operation, “no operation”, “addition”, “subtraction”, “comparison operation”, “left shift”, “right shift”, “immediate update”, or “bit masking”.

When the operation operand is encoded as above, the amount of information needed for representing the operation request can be reduced. As described above, in the example of FIG. 11, the eight types of operation can be represented by the three bits.

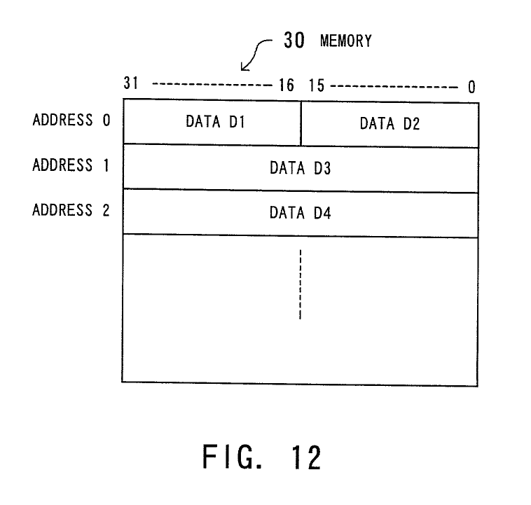

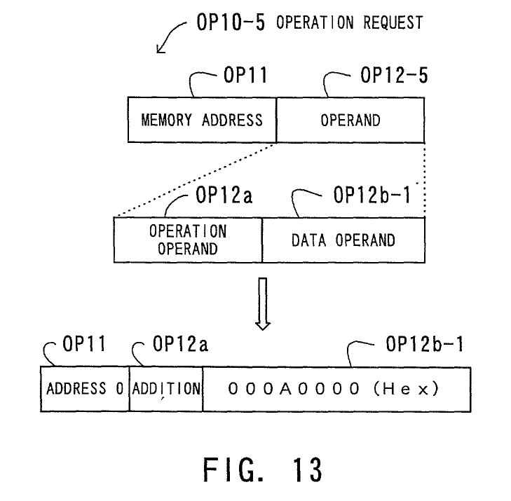

Next, an operation request which requests an operation performed on a plurality of data items is explained below. FIG. 12 is a diagram illustrating an exemplary case wherein two data items are stored at an address of the memory 30. In the example of FIG. 12, a data item D1 is stored in the bits 31 to 16 at the memory address “0”, and another data item D2 is stored in the bits 15 to 00 at the memory address “0”. At each of the addresses following the address “0”, only one data item is stored. FIG. 13 is a diagram illustrating the sixth example of the format of the operation request, which requests an operation to be performed on a plurality of data items.

The operation request OP10-5 illustrated in FIG. 13 is comprised of the aforementioned memory address OP11 and an operand OP12-5, and the operand OP12-5 is comprised of the aforementioned operation operand OP12a and a data operand OP12b-1. The format of the operation request OP10-5 illustrated in FIG. 13 is different from the format of the operation request OP10 illustrated in FIG. 6 in that the data operand OP12b-1 in the operation operand OP12-5 substantially includes two data operands. For example, when addition of ten to the data D1 stored in the bits 31 to 16 at the memory address “0” (as illustrated in FIG. 12) is requested, and no operation is requested on the data D2, the data operand OP12b-1 can be “000A0000” in hexadecimal notation, where it is assumed that the data operand OP12b-1 is represented with 32 bits. That is, the 16 more significant bits of the data operand OP12b-1 indicates “000A” in hexadecimal notation as a data operand for the data Dl, and the 16 less significant bits of the data operand OP12b-1 indicates “0000” (All zero) in hexadecimal notation as a data operand for the data D2. As described above, when the data operand is divided into two portions, it is unnecessary to attach an offset address for each data to the operation request even when more than one data item is stored at one memory address.

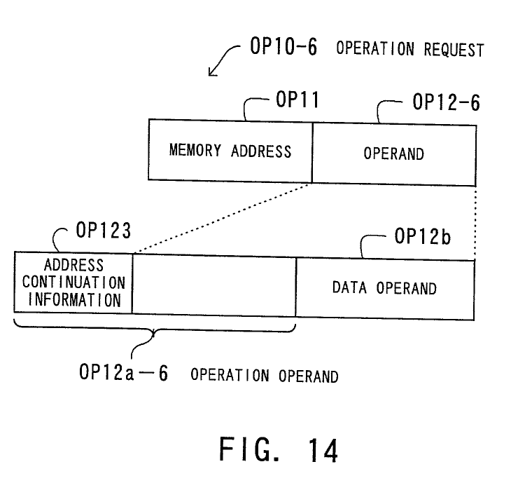

Next, an operation request which requests an operation to be performed on a data item stored at more than one consecutive address of the memory 30 is explained below. FIG. 14 is a diagram illustrating the seventh example of the format of the operation request, which requests an operation to be performed on a data item stored at more than one consecutive address of the memory 30. The operation request OP10-6 illustrated in FIG. 14 is comprised of the aforementioned memory address OP11 and an operand OP12-6, and the operand OP12-6 is comprised of an operation operand OP12a-6 and the aforementioned data operand OP12b. The format of the operation request OP10-6 illustrated in FIG. 14 is different from the format of the operation request OP10 illustrated in FIG. 6 in that the operation operand OP12a-6 further includes address continuation information OP123, which indicates whether or not an operation requested by the operation request is to be performed on a data item which is stored at more than one consecutive address of the memory 30. Alternatively, the address continuation information OP123 may indicate the number of addresses storing a data item on which the requested operation is to be performed. In either case, when the address continuation information OP123 substantially indicates that the requested operation is to be performed on a data item which is stored at more than one consecutive address of the memory 30, the memory address OP11 indicates one of the more than one consecutive address, e.g., the minimum address of the more than one consecutive address. When the address continuation information OP123 indicates that the number of the more than one consecutive address is n, the operation of reading the data item by the operation performing unit 22 is n consecutive reading operations for reading the contents at the n consecutive addresses. Next, the operation requested by the operation request is performed on the data item. Then, the result of the operation is stored at the n consecutive addresses by n consecutive writing operations for writing the n portions of the result of the operation at the n consecutive addresses. When the operation request as described above is used for requesting an operation performed on a data item stored at more than one consecutive address of the memory, it is unnecessary for the operation request to contain all of the more than one consecutive address. Therefore, the amount of information needed for representing the operation request can be reduced, and the memory access operations becomes more efficient.

(3) Control of Random Access Queue

Details of the control of the random access queue 21a by the operation-request control unit 21b are explained below.

FIG. 15 is a diagram illustrating an exemplary course of states of the random access queue 21a. Initially, the random access queue 21a stores operation requests OP1 to OP5. The operation requested by the operation request OP1 is addition of one to the data stored at the address “0” of the memory 30, the operation requested by the operation request OP2 is addition of one to the data stored at the address “4”, the operation requested by the operation request OP3 is addition of three to the data stored at the address “0”, the operation requested by the operation request OP4 is addition of one to the data stored at the address “2”, and the operation requested by the operation request OP5 is addition of one to the data stored at the address “1”, where the operation requested by each operation request is indicated by the aforementioned data operand and operation operand of the operation request.

The operation-request control unit 21b monitors the contents of the random access queue 21a, and determines whether or not more than one operation request currently stored in the random access queue 21a contains an identical memory address, and whether or not at least one operation request currently stored in the random access queue 21a contains a memory address adjacent to another memory address contained in another operation request previously output from the random access queue 21a. When the operation-request control unit 21b finds the more than one operation request containing an identical memory address, or the at least one operation request containing a memory address adjacent to another memory address contained in the operation request which is previously output from the random access queue 21a, the operation-request control unit 21b controls the random access queue 21a so as to output the above more than one operation request or the above at least one operation request to the operation performing unit 22 with higher priority than the other operation requests.

In step S40, the operation-request control unit 21b recognizes that the operation requests OP1 and OP3 request operations to be performed on data stored at the identical memory address “0”, and the operation request OP5 contains the memory address “1”, which is adjacent to the address “0” contained in the operation requests OP1 and OP3. In step S41, the operation-request control unit 21b controls the random access queue 21a so as to output the operation request OP1. In step S42, the operation-request control unit 21b controls the random access queue 21a so as to output the operation request OP3, which contains the same memory address as the operation request OP1. In step S43, the operation-request control unit 21b controls the random access queue 21a so as to output the operation request OP5, which contains a memory address adjacent to the memory address contained in the operation request OP1.

When more than one operation request containing an identical memory address and at least one operation request containing a memory address adjacent to another memory address contained in an operation request which is previously output are output with higher priority than the other operation requests as described above, the operation performing unit 22 can successively access the identical address or consecutive addresses of the memory 30 for the above more than one operation request or the above at least one operation request. Therefore, total access time needed for the above operation requests can be reduced, and the efficiency in the memory access operation can be increased.

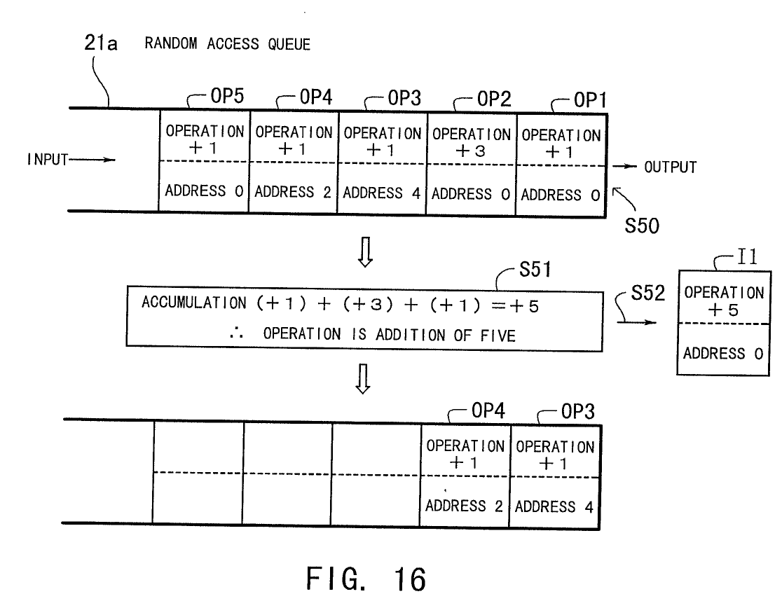

FIG. 16 is a diagram illustrating an example of the operation of accumulating more than one operation requested by more than one operation request stored in the random access queue 21a. Initially, the random access queue 21a stores operation requests OP1 to OP5. The operation requested by the operation request OP1 is addition of one to the data stored at the address “0” of the memory 30, the operation requested by the operation request OP2 is addition of three to the data stored at the address “0”, the operation requested by the operation request OP3 is addition of one to the data stored at the address “4”, the operation requested by the operation request OP4 is addition of one to the data stored at the address “2”, and the operation requested by the operation request OP5 is addition of one to the data stored at the address “0”.

The operation-request control unit 21b monitors the contents of the random access queue 21a, and determines whether or not more than one operation request currently stored in the random access queue 21a contains an identical memory address. When the operation-request control unit 21b finds more than one operation request being stored in the random access queue 21a and containing an identical memory address, the operation-request control unit 21b generates an accumulated operation request, and outputs the accumulated operation request to the operation performing unit 22, instead of the more than one operation request.

In step S50, the operation-request control unit 21b recognizes that the operation requests OP1, OP2, and OP5 contain the identical memory address “0”. In step S51, the operation-request control unit 21b performs an operation of accumulating the operations requested by the operation requests OP1, OP2, and OP5. In this example, the accumulated operation is addition of five to the data stored at the memory address “0”, since (+1)+(+3)+(+1)=+5. In step S52, the operation-request control unit 21b invalidates the operation requests OP1, OP2, and OP5 stored in the random access queue 21a, generates an accumulated operation request I1 which requests addition of five to the data stored at the memory address “0”, and outputs the accumulated operation request to the operation performing unit 22.

As described above, the operation-request control unit 21b accumulates operations to be performed on data stored at an identical memory address, generates an accumulated operation request, and outputs the accumulated operation request to the operation performing unit 22. Therefore, the total access time to the memory 30 can be reduced, and the memory access operations become more efficient.

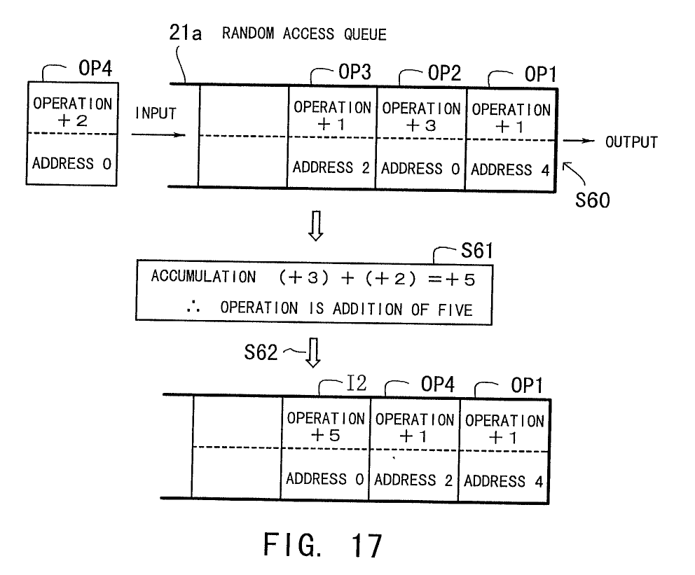

FIG. 17 is a diagram illustrating an example of the operation of accumulating operations requested by an operation request which is to be written in the random access queue 21a and at least one operation request which is already stored in the random access queue 21a. Initially, the random access queue 21a stores operation requests OP1 to OP3. The operation requested by the operation request OP1 is addition of one to the data stored at the address “4” of the memory 30, the operation requested by the operation request OP2 is addition of three to the data stored at the address “0”, and the operation requested by the operation request OP3 is addition of one to the data stored at the address “2”. In addition, a further operation request OP4 which is to be written in the random access queue 21a requests addition of two to the data stored at the memory address “0”.

The operation-request control unit 21b monitors the contents of the random access queue 21a, and determines whether or not at least one operation request currently stored in the random access queue 21a contains a memory address which is identical to a memory address contained in another operation request which is to be written in the random access queue 21a. When the operation-request control unit 21b finds at least one operation request being stored in the random access queue 21a and containing an identical memory address to the memory address contained in the operation request which is to be written in the random access queue 21a, the operation-request control unit 21b generates an accumulated operation request, and stores the accumulated operation request in the random access queue 21a, instead of the at least one operation request.

In step S60, the operation-request control unit 21b recognizes that the operation request OP2 stored in the random access queue 21a contains the memory address “0”, which is identical to the memory address contained in the operation request OP4 which is to be written in the random access queue 21a. In step S61, the operation-request control unit 21b performs an operation of accumulating the operations requested by the operation requests OP2 and OP4. In this example, the accumulated operation is addition of five to the data stored at the memory address “0”, since (+3)+(+2)=+5. In step S62, the operation-request control unit 21b invalidates the operation requests OP2 and OP4, generates an accumulated operation request I2 which requests addition of five to the data stored at the memory address “0”, and stores the accumulated operation request in the random access queue 21a.

As described above, when at least one operation request stored in the random access queue 21a contains an identical memory address to the memory address contained in the operation request which is to be written in the random access queue 21a, the operation-request control unit 21b accumulates operations requested by the at least one operation request and the operation request which is to be written in the random access queue 21a, invalidates the at least one operation request, and stores the accumulated operation request in the random access queue 21a, instead of the at least one operation request. Thus, the total access time to the memory 30 can be reduced, and the memory access operations become more efficient.

In the construction described above, each operation request received from the processor unit 10 is directly written in the random access queue 21a. However, it is possible to further provide a ready queue in the stage preceding the random access queue 21a so as to form a hybrid queue structure. The ready queue is a first-in first-out (FIFO) queue. Operation request received from the processor unit 10 are first stored in the ready queue, and are then transferred to the random access queue 21a in the order in which the operation requests are received from the processor unit 10. The operation-request control unit 21b must monitor the state of the random access queue 21a in order to recognize operation requests stored in the random access queue 21a. However, when a ready queue is arranged as above, the load imposed on the operation-request control unit 21b by the operations of monitoring and controlling the random access queue 21a can be reduced.

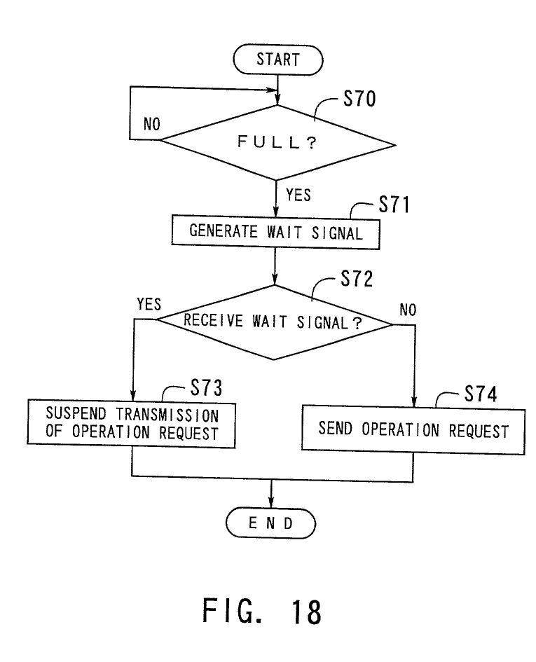

Next, operations which are performed when the random access queue 21a is full of operation requests are explained below. FIG. 18 is a flow diagram illustrating examples of operations performed when the random access queue 21a is full of operation requests.

In step S70, the operation-request control unit 21b monitors the state of the random access queue 21a in order to determine whether or not the random access queue 21a is full of operation requests. When yes is determined in step S70, the operation goes to step S71. When no is determined in step S70, the operation-request control unit 21b continues the monitoring operation. In step S71, the operation-request control unit 21b generates a wait signal, and sends the wait signal to the processor unit 10 in order to make the processor unit 10 suspend processing of an event following the events corresponding to the operation requests which have already been sent to the memory interface unit 20. In step S72, the processor unit 10 determines whether or not the processor unit 10 receives the wait signal. When yes is determined in step S72, the operation goes to step S73. When no is determined in step S72, the operation goes to step S74. In step S73, the processor unit 10 suspends an operation of sending an operation request to the memory interface unit 20, and enters a wait state. In step S74, the processor unit 10 sends an operation request to the memory interface unit 20.

As described above, when the random access queue 21a is full of operation requests, the operation-request control unit 21b makes the processor unit 10 suspend an operation of sending an operation request to the memory interface unit 20, and enter a wait state. Therefore, omission of update of data due to overflow of the random access queue 21a can be prevented, and the reliability of data can be maintained.

Next, operations of the operation-request storing unit are explained below for the case where the random access queue is realized by a cache memory.

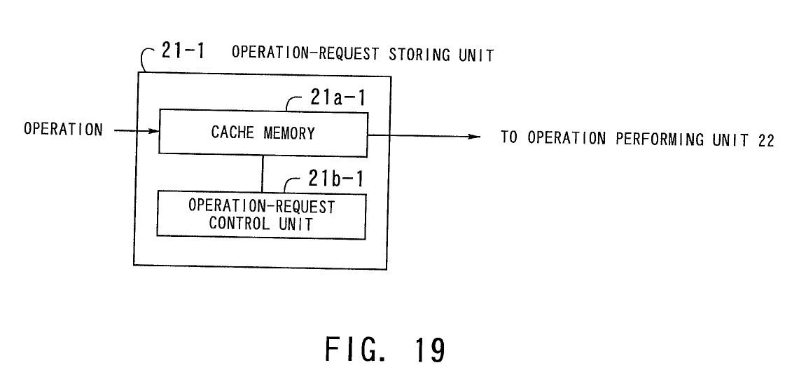

FIG. 19 is a diagram illustrating an example of the construction of the operation-request storing unit. The operation-request storing unit 21-1 illustrated in FIG. 19 comprises a cache memory 21a-1 and an operation-request control unit 21b-1. The operation-request control unit 21b-1 controls operation requests stored in the cache memory 21a-1, as explained above with reference to FIGS. 15 to 18. When the operation-request control unit 21b-1 stores in the cache memory 21a-1 a new operation request containing a memory address, the operation-request control unit 21b-1 controls the cache memory 21a-1 as follows.

When an operation request containing a memory address which is identical to the memory address contained in the above new operation request is already stored in the cache memory 21a-1, i.e., a cache hit occurs, the operation-request control unit 21b-1 performs the aforementioned operation of accumulating operations requested by the above new operation request and the operation request which is already stored in the cache memory 21a-1. When an operation request containing a memory address which is identical to the memory address contained in the above new operation request is not stored in the cache memory 21a-1, i.e., a cache miss occurs, and there is an available space in the cache memory 21a-1, the operation-request control unit 21b-1 stores the above new operation request in the available space of the cache memory 21a-1. When an operation request containing a memory address which is identical to the memory address contained in the above new operation request is not stored in the cache memory 21a-1, i.e., a cache miss occurs, and there is no available space in the cache memory 21a-1, the operation-request control unit 21b-1 replaces another operation request which is already stored in the cache memory 21a-1 with the above new operation request after the operation request which is already stored in the cache memory 21a-1 is output to the operation performing unit 22, and executed by the operation performing unit 22, and the result of the execution is written in the memory 30.

Finally, characteristic operations of the operation performing unit 22 are explained below.

In consideration of locality of memory access, when the operation performing unit 22 accesses an address of the memory 30 for reading data at the address in accordance with an operation request, the operation performing unit 22 also reads data at addresses near (e.g., adjacent to) the above address corresponding to the operation request, and holds the data corresponding to the near addresses. Thereafter, when data at one of the above near addresses is requested by another operation request, it is unnecessary to access the address of the memory 30, and the above data held by the operation performing unit 22 can be used for performing an operation requested by the operation request on the data. In addition, updated data corresponding to the above near addresses may be written together in the memory 30. Since there is address continuity between memory read addresses and memory write addresses, it is possible to efficiently access the memory when the operations of reading and writing data are performed as above.

(4) ATM Communication Control Apparatus

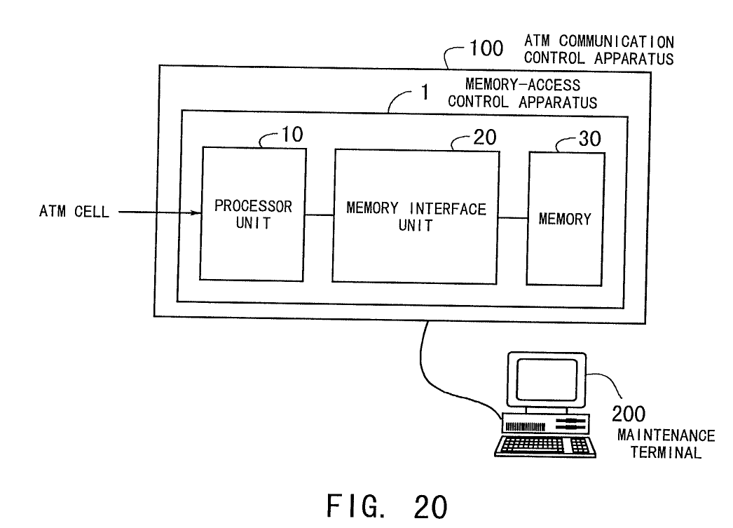

An ATM communication control apparatus utilizing a memory access system according to the present invention is explained below. FIG. 20 is a diagram illustrating an outline of an essential portion of the ATM communication control apparatus. The ATM communication control apparatus 100 illustrated in FIG. 20 contains a memory access system 1, and manages and controls ATM communications. The memory access system 1 comprises the processor unit 10, the memory interface unit 20, and the memory 30.

The management and control of the ATM communications include processing for counting cell numbers, statistical processing for OAM performance monitoring, billing processing, or the like. The ATM communication control apparatus 100 generates an operation request for management and control of the ATM communications as above, and performs an operation requested by the operation request. The operation includes, for example, reference to or update of a statistical value. A result of the operation is transmitted to a maintenance terminal 200 in order to inform a maintenance person of the result of the operation.

Hereinbelow, explanations are provided for operations of the ATM communication control apparatus 100 which are performed for performance monitoring (PM) of an ATM communication system in accordance with the ITU-T Recommendations I.610, which specifies a kind of statistical processing for realizing the OAM performance monitoring.

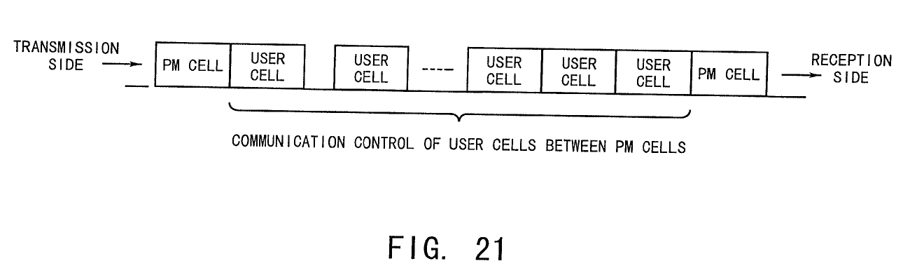

FIG. 21 is a diagram illustrating insertion of PM cells between user cells for realizing performance monitoring. PM cells are inserted into a flow of user cells at predetermined intervals. The insertion is made on the transmitter side, and the user cells between the PM cells are monitored on the receiver side. The number of lost (discarded) cells, erroneously inserted cells, or the like are counted between each adjacent pair of PM cells for each connection, and statistics are obtained. The user cells between each adjacent pair of PM cells are called a block of user cells.

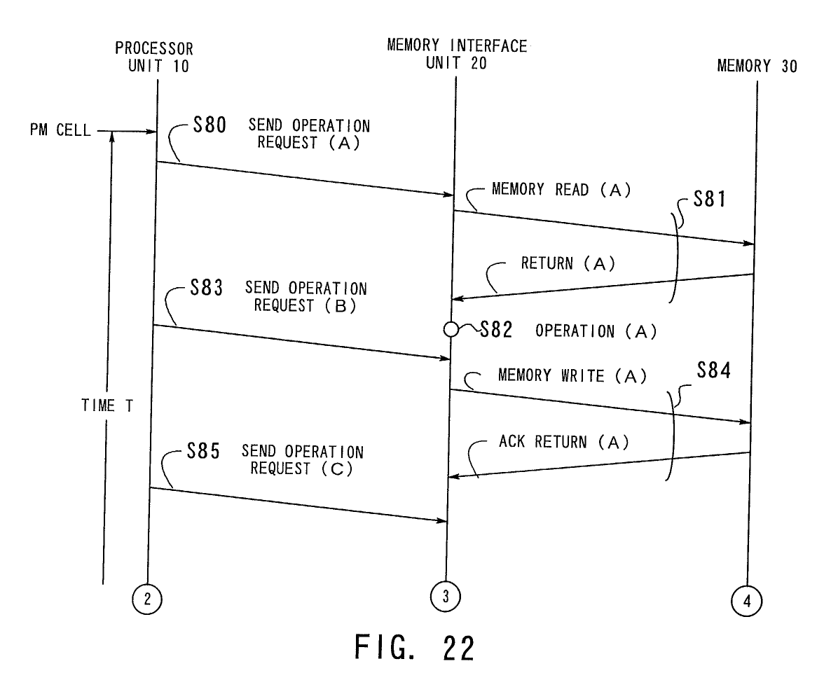

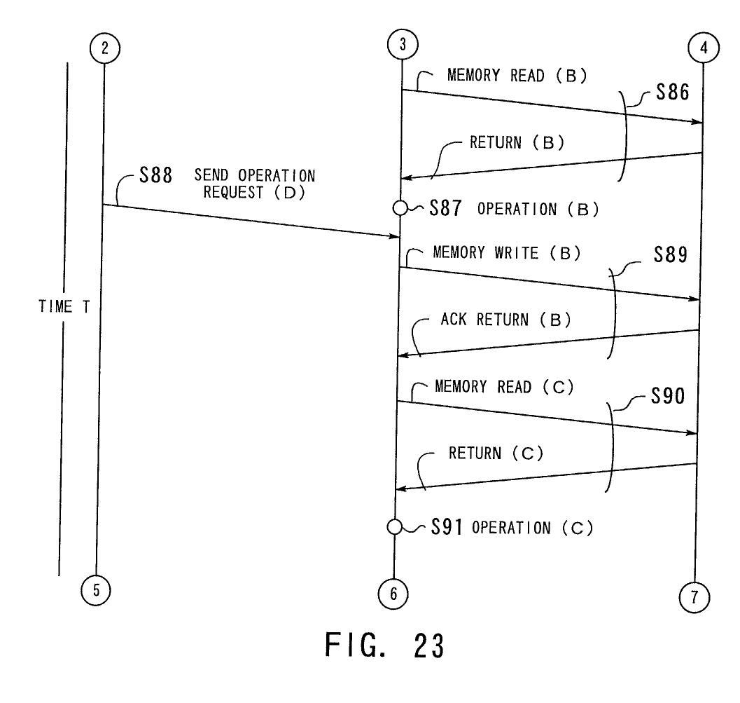

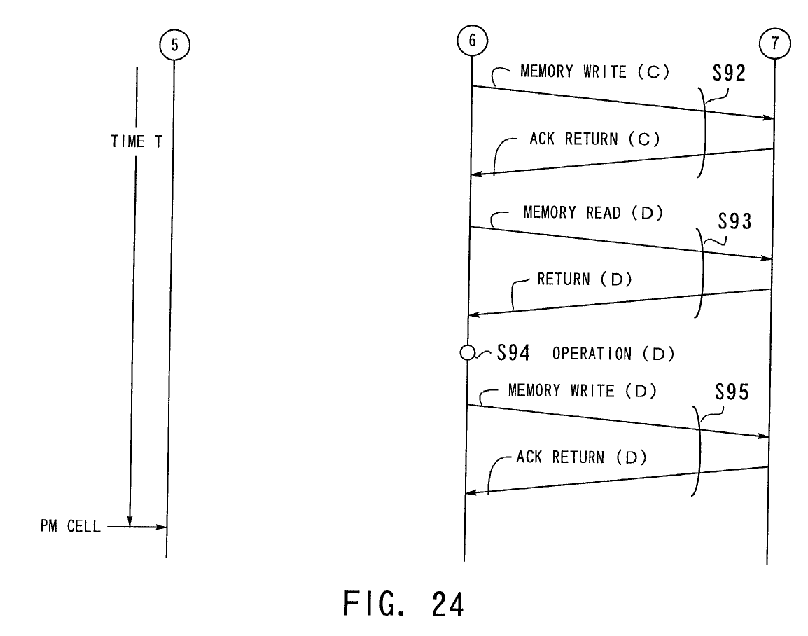

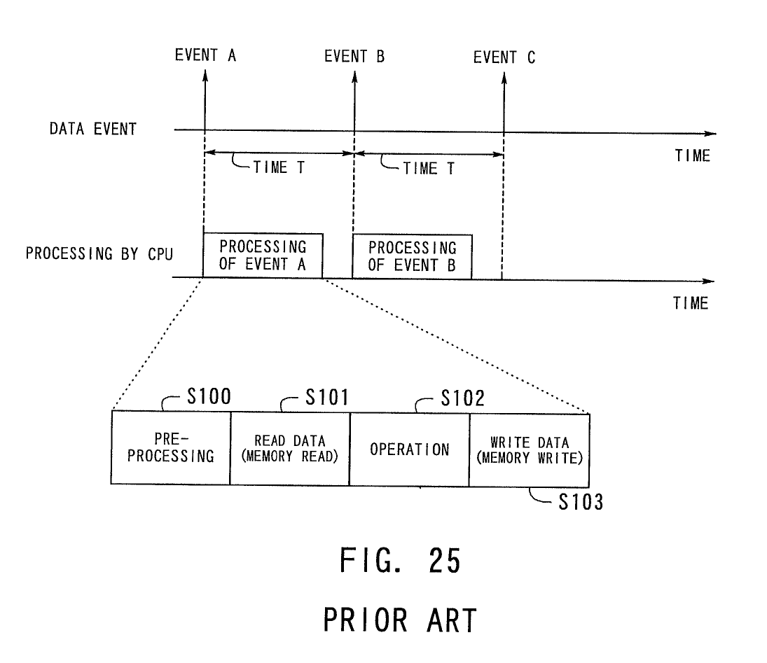

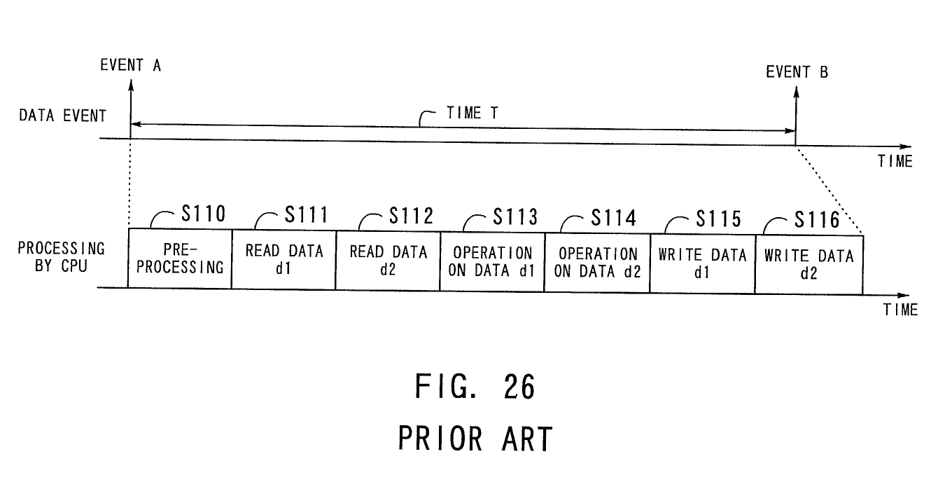

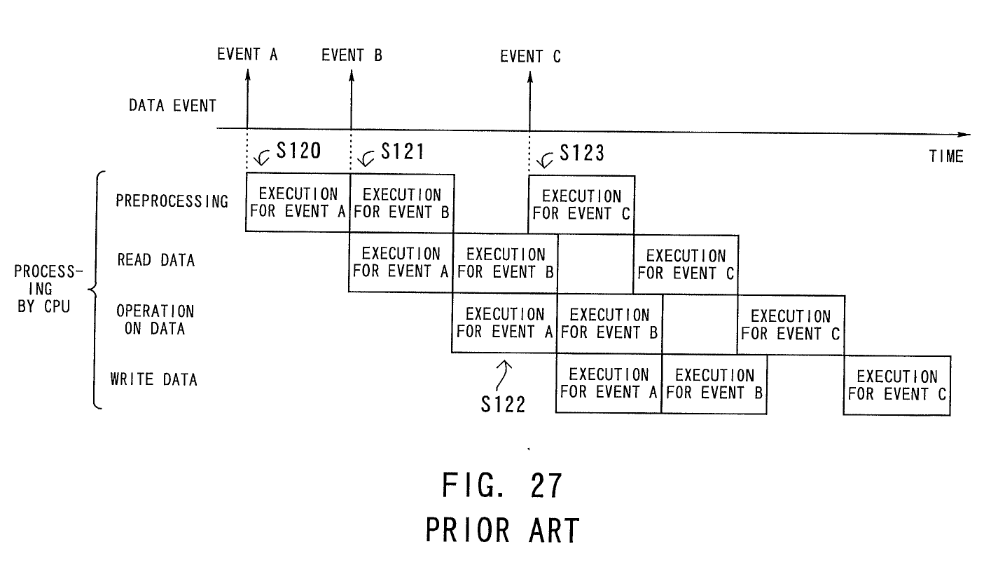

FIGS. 22 to 24 are sequence diagrams of examples of operations performed for monitoring performance of a block. The sequence illustrated in FIGS. 22 to 24 includes operations of updating the statistical values of: the number of transmitted cells having a cell loss priority (CLP) of “0” (indicated as a data item “A” in FIGS. 22 to 24), the number of transmitted cells having a cell loss priority (CLP) of “1” (indicated as a data item “B” in FIGS. 22 to 24), the number (Total CLP0+1) of transmitted cells having cell loss priorities (CLP) of “0” and “1” (indicated as a data item “C” in FIGS. 22 to 24), and the SECB (Severely Errored Cell Block) Errored (indicated as a data item “D” in FIGS. 22 to 24).

The CLP is information represented by one bit field contained in each cell, and indicates discardability (i.e., a priority) of the cell. In the case of network congestions, cells with CLP=1 are first discarded. That is, the number of transmitted cells having a cell loss priority (CLP) of “0” are the number of cells having a high priority in the block, the number of transmitted cells having a cell loss priority (CLP) of “1” are the number of cells having a low priority in the block, and the number (Total CLP0+1) of transmitted cells having cell loss priorities (CLP) of “0” and “1” is the total number of cells having high and low priorities in the block. The SECB (Severely Errored Cell Block) Errored is information represented by one bit field, and indicates that the number of cells discarded in the block exceeds a predetermined threshold, i.e., the block includes a great number of errors. In the example of FIGS. 22 to 24, the length of each block corresponds to a time T.

When an event corresponding to the data item “A” occurs, in step S80, the processor unit 10 generates an operation request for update of the data item “A”, and sends the operation request to the memory interface unit 20. In step S81, the memory interface unit 20 receives the operation request, and makes read access to the data item “A” stored in the memory 30 based on the operation request. In step S82, the memory interface unit 20 performs the operation on the data item “A” read from the memory 30. When an event corresponding to the data item “B” occurs, in step S83, the processor unit 10 generates an operation request for update of the data item “B”, and sends the operation request to the memory interface unit 20. In step S84, the memory interface unit 20 writes in the memory 30 a result of the operation performed on the data item “A”, and receives an acknowledge return from the memory 30. When an event corresponding to the data item “C” occurs, in step S85, the processor unit 10 generates an operation request for update of the data item “C”, and sends the operation request to the memory interface unit 20. In step S86, the memory interface unit 20 makes read access to the data item “B” stored in the memory 30 based on the operation request for update of the data item “B”. In step S87, the memory interface unit 20 performs the operation on the data item “B” read from the memory 30. When an event corresponding to the data item “D” occurs, in step S88, the processor unit 10 generates an operation request for update of the data item “D”, and sends the operation request to the memory interface unit 20. In step S89, the memory interface unit 20 writes in the memory 30 a result of the operation performed on the data item “B”, and receives an acknowledge return from the memory 30. In step S90, the memory interface unit 20 makes read access to the data item “C” stored in the memory 30 based on the operation request for update of the data item “C”. In step S91, the memory interface unit 20 performs the operation on the data item “C” read from the memory 30. In step S92, the memory interface unit 20 writes in the memory 30 a result of the operation performed on the data item “C”, and receives an acknowledge return from the memory 30. In step S93, the memory interface unit 20 makes read access to the data item “D” stored in the memory 30 based on the operation request for update of the data item “D”. In step S94, the memory interface unit 20 performs the operation on the data item “D” read from the memory 30. In step S95, the memory interface unit 20 writes in the memory 30 a result of the operation performed on the data item “D”, and receives an acknowledge return from the memory 30.

As explained above, the ATM communication control apparatus 100 according to the present invention generates an operation request for update of a data item (statistical value), and sends the operation request to the memory interface unit 20. Then, the memory interface unit 20 updates the statistical value by reading the data item from the memory, performing a requested operation on the data item, and writing the result of the operation in the memory.

In the above example, the requested operation is addition, which can be indicated by one bit in the operation request. Therefore, the processor unit 10 sends to the memory interface unit 20 only one bit indicating the addition of one, N bits indicating a memory address, and sixteen bits representing an augend.

Therefore, when it is required that the above processing is completed within the above-mentioned time T, the processor unit 10 needs a bandwidth of 68 bits/T for sending information on the requested operations and augends for the four data items A to D, in addition to the bandwidth needed for sending the memory addresses. The above bandwidth of 68 bits/T is determined as

(16+1) bits×4/T=68 bits/T. (1)

Conventionally, the CPU updates the data items in the memory by itself. That is, when a PM cell is received, the CPU determines each statistical data item which is to be updated, reads a corresponding data item from the memory, performs an operation on (e.g., addition of n to) the data item, and writes a result of the operation in the memory. When each of the data items A to D is represented by 32 bits, and it is required that the above processing is completed within the above-mentioned time T, the CPU needs a bandwidth of 256 bits/T for transferring the four data items A to D between the CPU and the memory in the read and write access, in addition to the bandwidth needed for sending the memory addresses. The above bandwidth of 256 bits/T is determined as

32 bits×2×4/T=256 bits/T. (2)

That is, except for the bandwidth needed for sending the memory addresses, the bandwidth required by the processor unit 10 in the present invention is one-fourth the bandwidth required by the CPU in the conventional technique.

An operation of referring to the above statistical values is explained below.

For example, when it is necessary to determine whether or not a statistical value stored in the memory 30 is “ALL 1”, conventionally, the CPU reads the statistical value from the memory, and determines whether or not the statistical value is “ALL 1”. On the other hand, according to the present invention, when it is necessary to determine whether or not a statistical value stored in the memory 30 is “ALL 1”, the processor unit 10 attaches one bit to an operation request, and sends the operation request to the memory interface unit 20, where the attached bit indicates a request for determination as to whether or not the statistical value is “ALL 1”. Then, the memory interface unit 20 accesses the memory 30, determines whether or not the statistical value is “ALL 1”, and sends only the result of the determination to the processor unit 10. Therefore, when the statistical value is represented by 32 bits, conventionally, the CPU needs a bandwidth of 32 bits/T for making the above determination. On the other hand, according to the present invention, the processor unit 10 needs only two bits for sending the operation request to the memory interface unit 20, and receiving the result from the memory interface unit 20, except for the bits needed for sending the memory addresses. Thus, according to the present invention, the necessary bandwidth can be reduced to one-sixteenth the bandwidth needed in the conventional technique.

As explained above, in the ATM communication control apparatus 100 according to the present invention, the processor unit 10 only generates an operation request, and sends the operation request to the memory interface unit 20, and the memory interface unit 20 makes memory access and performs the operation requested by the operation request, independently of the processor unit 10. Therefore, the bandwidth between the processor unit 10 and the memory 30 can be reduced, and efficient, high-quality memory access operations can be achieved. Thus, the system throughput can be improved.

The memory access system 1 according to the present invention can also be applied to any communication systems other than the ATM communication systems. In particular, the use of the memory access system 1 according to the present invention is advantageous in communication systems which need a great amount of memory capacity. In such communication systems, the present invention can greatly contribute to improvement of system reliability.

(5) Other Matters

(i) The foregoing is considered as illustrative only of the principle of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

(ii) All of the contents of the Japanese patent application, No.2000-139859 are incorporated into this specification by reference.

What is claimed is:

1. A memory access system comprising:
a memory which stores data;
a processor unit including,
an operation-request generating unit which generates an operation request for an operation which is to be performed on said data, and
an operation-request sending unit which sends said operation request to a memory interface unit; and
said memory interface unit including,
an operation-request storing unit which receives and temporarily stores said operation request,
an operation performing unit which operates independently of said processor unit so as to access said memory based on said operation request, and perform said operation on said data, and
an operation-result sending unit which sends a result of said operation to said processor unit.

2. A memory access system according to claim 1, wherein said operation request contains a memory address and an operand which indicates said operation.

3. A memory access system according to claim 2, wherein said operand includes an operation operand which indicates a type of said operation and a data operand which indicates additional data used in said operation.

4. A memory access system according to claim 3, wherein said operation operand includes at least one of first, second, and third bits, where said first bit indicates an operation of clearing said data stored in said memory, said second bit indicates an immediate update operation of updating said data with said additional data, and said third bit indicates an operation of masking said data.

5. A memory access system according to claim 4, wherein said operation performing unit performs said operation of clearing said data stored in said memory, or said immediate update operation, without read access to said memory.

6. A memory access system according to claim 3, wherein said operand includes at least one mask bit which masks said data stored in said memory.

7. A memory access system according to claim 3, wherein said operation operand is encoded.

8. A memory access system according to claim 3, wherein said operation is to be performed on a plurality of portions of said data, and said data operand includes a plurality of portions respectively corresponding to said plurality of portions of said data.

9. A memory access system according to claim 3, wherein said operation request includes an address continuation indication which indicates that said data on which said operation is to be performed is stored at a plurality of consecutive addresses of said memory, and said memory address contained in said operation request is one of said plurality of consecutive addresses.

10. A memory access system according to claim 9, wherein said plurality of consecutive addresses are n consecutive addresses, and said operation performing unit performs n successive data reading operations, said operation to be performed on said data, and n successive data writing operations.

11. A memory access system according to claim 1, wherein said operation-request storing unit comprises a queue which stores said operation request, and an operation-request controlling unit which controls said operation request stored in said queue.

12. A memory access system according to claim 11, wherein said operation-request controlling unit successively reads from said queue a plurality of operation requests having an identical memory address, with high priority.

13. A memory access system according to claim 11, wherein said operation-request controlling unit successively reads from said queue a plurality of operation requests respectively containing a plurality of consecutive memory addresses, with high priority.

14. A memory access system according to claim 11, wherein said operation-request controlling unit invalidates a plurality of operation requests containing an identical memory address and being stored in said queue, and generates an accumulated operation request by accumulating a plurality of operations requested by said plurality of operation requests.

15. A memory access system according to claim 11, wherein said operation-request controlling unit invalidates at least one operation request being stored in said queue and containing a memory address which is identical to a memory address contained in an operation request which is to be written in said queue, and generates an accumulated operation request by accumulating a plurality of operations requested by said at least one operation request and said operation request which is to be written in said queue.

16. A memory access system according to claim 11, wherein, when said queue is full of operation requests, said operation-request controlling unit makes said processor unit suspend processing of an operation request following said operation requests in said queue.

17. A memory access system according to claim 11, wherein said queue comprises a random access queue and a ready queue.

18. A memory access system according to claim 1, wherein said operation-request storing unit comprises a cache memory which stores a plurality of operation requests, and an operation-request controlling unit which controls said operation request stored in said cache memory, and accumulates a plurality of operations requested by a plurality of operation requests containing an identical memory address and being stored in said cache memory.

19. A memory access system according to claim 1, wherein, when said operation performing unit reads from said memory first data corresponding to a first memory address contained in said operation request, said operation performing unit also reads second data corresponding to second memory addresses near said first memory address, and writes in said memory results of operations performed on said second data corresponding to said second memory addresses, together with a result of said operation performed on said first data corresponding to said first memory address.

20. A memory access system according to claim 1, wherein said processor unit is realized by software, and said memory interface unit is realized by hardwired logic circuits.

21. An ATM communication control apparatus comprising:
a memory which stores data relating to control of ATM communications;
a processor unit including,
an operation-request generating unit which generates an operation request for an operation which is to be performed on said data, and
an operation-request sending unit which sends said operation request to a memory interface unit; and
said memory interface unit including,
an operation-request storing unit which receives and temporarily stores said operation request,
an operation performing unit which operates independently of said processor unit so as to access said memory based on said operation request, and perform said operation on said data, and
an operation-result sending unit which sends a result of said operation to said processor unit.

22. An ATM communication control apparatus according to claim 21, wherein said operation performed by said operation performing unit relates to at least one of cell number counting, statistical processing for OAM performance monitoring, and billing.

23. A memory interface unit comprising:
an operation-request receiving unit which receives an operation request for an operation which is to be performed on data stored in a memory;
an operation-request storing unit which temporarily stores said operation request;
an operation performing unit which operates accesses said memory based on said operation request, and performs said operation on said data; and
an operation-result outputting unit which outputs a result of said operation.

24. A memory interface unit according to claim 23, wherein said operation request contains a memory address and an operand which indicates said operation.

25. A memory interface unit according to claim 24, wherein said operand includes an operation operand which indicates a type of said operation and a data operand which indicates additional data used in said operation.

26. A memory interface unit according to claim 25, wherein said operation operand includes at least one of first, second, and third bits, where said first bit indicates an operation of clearing said data stored in said memory, said second bit indicates an immediate update operation of updating said data with said additional data, and said third bit indicates an operation of masking said data.

27. A memory interface unit according to claim 26, wherein said operation performing unit performs said operation of clearing said data stored in said memory, or said immediate update operation, without read access to said memory.

28. A memory interface unit according to claim 25, wherein said operand includes at least one mask bit which masks said data stored in said memory.

29. A memory interface unit according to claim 25, wherein said operation operand is encoded.

30. A memory interface unit according to claim 25, wherein said operation is to be performed on a plurality of portions of said data, and said data operand includes a plurality of portions respectively corresponding to said plurality of portions of said data.

31. A memory interface unit according to claim 25, wherein said operation request includes an address continuation indication which indicates that said data on which said operation is to be performed is stored at a plurality of consecutive addresses of said memory, and said memory address contained in said operation request is one of said plurality of consecutive addresses.

32. A memory interface unit according to claim 31, wherein said plurality of consecutive addresses are n consecutive addresses, and said operation performing unit performs n successive data reading operations, said operation to be performed on said data, and n successive data writing operations.

33. A memory interface unit according to claim 23, wherein said operation-request storing unit comprises a queue which stores said operation request, and an operation-request controlling unit which controls said operation request stored in said queue.

34. A memory interface unit according to claim 33, wherein said operation-request controlling unit successively reads from said queue a plurality of operation requests having an identical memory address, with high priority.

35. A memory interface unit according to claim 33, wherein said operation-request controlling unit successively reads from said queue a plurality of operation requests respectively containing a plurality of consecutive memory addresses, with high priority.

36. A memory interface unit according to claim 33, wherein said operation-request controlling unit invalidates a plurality of operation requests containing an identical memory address and being stored in said queue, and generates an accumulated operation request by accumulating a plurality of operations requested by said plurality of operation requests.

37. A memory interface unit according to claim 33, wherein said operation-request controlling unit invalidates at least one operation request being stored in said queue and containing a memory address which is identical to a memory address contained in an operation request which is to be written in said queue, and generates an accumulated operation request by accumulating a plurality of operations requested by said at least one operation request and said operation request which is to be written in said queue.

38. A memory interface unit according to claim 33, wherein, when said queue is full of operation requests, said operation-request controlling unit makes said processor unit suspend processing of an operation request following said operation requests in said queue.

39. A memory interface unit according to claim 33, wherein said queue comprises a random access queue and a ready queue.

40. A memory interface unit according to claim 23, wherein said operation-request storing unit comprises a cache memory which stores a plurality of operation requests, and an operation-request controlling unit which controls said operation request stored in said cache memory, and accumulates a plurality of operations requested by a plurality of operation requests containing an identical memory address and being stored in said cache memory.

41. A memory interface unit according to claim 23, wherein, when said operation performing unit reads from said memory first data corresponding to a first memory address contained in said operation request, said operation performing unit also reads second data corresponding to second memory addresses near said first memory address, and writes in said memory results of operations performed on said second data corresponding to said second memory addresses, together with a result of said operation performed on said first data corresponding to said first memory address.

42. A memory interface unit according to claim 23, wherein said operation-request receiving unit, said operation-request storing unit, said operation performing unit, and said operation-result sending unit are realized by hardwired logic circuits.
